(19) United States
(12) Patent Application Publication
(10) Pub. No.: US 2008/0129425 A1
(43) Pub. Date: Jun. 5, 2008

(54) Electric Switching Device Comprising Magnetic And/Or Fluidic Adjusting Elements

(76) Inventors: Markus Leipold, Muenchen (DE); Helmut Hingrainer, Raubling (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/666,699

(22) PCT Filed: Oct. 21, 2005
(86) PCT No.: PCT/EP05/11348

§ 371 Date: Sep. 12, 2007

(30) Foreign Application Priority Data
Oct. 29, 2004 (DE) 10 2004 052 592.7
Mar. 18, 2005 (DE) 10 2005 012 645.6

(51) Int. Cl. H01P 1/12; H01H 3/24

(52) U.S. Cl. 333/259; 200/81.9 M

(57) ABSTRACT

An electrical switching device, especially a high-frequency switching device, with an oblong, electrical switch element, which is arranged with one contact end between two counter-contact elements with a transverse distance from one another, and which can be moved transversely relative to its longitudinal direction optionally towards the one or the other counter-contact element by two adjustment elements disposed on both sides near to the switch element. In order to prevent or at least to minimize frictional processes during switching, the switch element consists at least partially of magnetic material, wherein the adjustment elements are formed by magnets, and wherein, the efficacy of the magnet, which is arranged on the side respectively opposite to the counter-contact element to be contacted, can be reduced or cancelled to allow a switching process.

The invention relates to an electrical switching circuit according to the preamble of claim 1 or claim 3.

A switching device of this kind is described in DE 101 03 814 A1. In particular, the switching device is used to switch off a power line for a high-frequency calibration line via different attenuation elements. For this purpose, it provides an oblong switch element, which can be moved transversely to its longitudinal direction by an adjustment element and optionally brought out of contact or into contact with a counter-contact surface at its end. In the contact position, the conduction of electrical current to the contact surfaces is dependent among other factors upon the mutual contact between the contact surface and the counter-contact surface. Contamination or particles can substantially impair the current conduction, especially if the contamination and/or particles consist of electrically non-conductive material.

An interference-free current conduction is particularly important for calibration lines, which are used as a reference for attenuation settings, for example, of signal generators or network analyzers. Calibration lines provide, for example, several four-pin switching devices arranged in series with identical and constant surge impedance at the input and output end, in each case providing adjustable, calibrated attenuation and the associated accurate level.

With the known high-frequency, electrical switching devices, as they are typically used in high-frequency calibration lines, the lateral switching movement of a switch element is achieved by applying an external, mechanical force via plungers, which push laterally against the switch element thereby causing it to move. Because of the lateral rotary movement executed by the switch element and the linear pushing movements of the plungers provided on both sides of the switch element, sliding movements occur in the region of contact between the plunger and the switch element, which give rise to abraded particles as a result of the friction caused. The risk of interference to the contact from the abraded particles caused by friction is particularly great if the switching device has an enclosed switching compartment, because the abraded particles remain in the switching compartment. However, even with an open switching compartment, there is a danger that the abraded particles enter between the contact surfaces and impair the electrical contact.

The invention is based upon the object of removing or at least reducing frictional processes and the resulting risk of impairment of the electrical contact through abraded particles in an electrical switching device of the type indicated in the introduction. In particular, the occurrence of abraded particles in the proximity of the contact surfaces should be avoided or at least reduced. Moreover, a simple design should be provided.

This object is achieved by the features of claim 1 or claim 3. Advantageous further developments of the invention are described in the dependent claims.

The invention is based upon the knowledge that no moving mechanical contact is required between the switch element and the adjustment elements when the switching-movement for the switch element is driven by magnetic and/or fluid forces; accordingly, sliding friction does not occur, and the associated abraded particles are not formed when the switching movements of the switch element are generated by magnetic and/or fluid forces.

In the case of the switching device according to the invention specified in claim 1, the switch element consists at least partially of magnetic material, and the adjustment elements are formed by magnets, wherein the efficacy of the magnet, which is arranged on the opposite side to the contacting counter-contact element, can be reduced or cancelled to allow a switching process. Accordingly, during a switching process, one of the two magnets fulfils the switching function—that is to say, moving the switch element towards the respective counter-contact—and the contact-holding function against the counter-contact element, wherein the efficacy of the magnet, which is opposite to the contacting counter-contact element, is reduced or cancelled. This can be achieved, for example, by taking the opposing magnet out of operation, for example, by switching off an electromagnet or supplying a reduced current, or by moving the switch element towards the counter-contact element to be contacted by means of an adjustment force exceeding the magnetic force of the opposing magnet, for example, an electromagnet or a permanent magnet.

This can be achieved, for example, with a nozzle disposed on the opposing side, from which a fluid flow is directed under pressure towards the facing side of the switch element, which fluid flow exerts an adjustment force on the switch element, which exceeds the magnetic force and moves the switch element towards the counter-contact element to be contacted.

The term “fluid flow” in the sense of the present application preferably means a gas flow, in particular, a flow of air, wherein, however, a liquid flow is also possible.

With regard to the switching device according to the invention as specified in the independent claim 3, a nozzle for a compressed fluid is arranged on the respective sides, on which the counter-contact elements are arranged, wherein the nozzles can be switched on optionally. With this embodiment according to the invention, the switching movement of the switch element and its contact holding against the respective counter-contact element is also realised by a fluid flow emitted under pressure from the respective nozzle, which generates an adjustment force through its impact on the switch element, which moves the switch element to the other side and holds it in contact with the counter-contact element.

Both of the switching devices according to claim 1 and claim 3 provide a contactless switching. Accordingly, the movement of the switch element towards the counter-contact element does requires either sliding, mechanical friction nor the resulting abraded particles, so that the electrical contact therefore remains unimpaired in this respect.

In each case, the invention is characterized by a simple embodiment, which allows it to be realized in a small-scale design, because it requires no mechanical connection between the switch element and the adjustment elements. As a result of the absence of a mechanical connection, the embodiments according to the invention are variable and adaptable with regard to the distances between the switch element and the adjustment elements; they can therefore be integrated into existing designs in a simple and advantageous manner.

The invention can also be realized in a very advantageous manner by arranging a magnet and a nozzle on the sides, on which the respective counter-contact elements are arranged. With this combined embodiment, the respective nozzle fulfils the movement function for the switch element, while the respective magnets fulfill the contact-holding function. Accordingly, the nozzle can be switched off, when the switch element is attracted by the respective magnet. During this movement, the respective magnet can support the movement function of the nozzle.

A substantial contribution is made towards simplification of the switching device, if the respective magnets are formed by a permanent magnet. In such a case, the efficacy of the relevant magnet can be cancelled by switching on the nozzle arranged on the same side, of which the fluid flow emitted exerts such a large motive force on the switch element, that the magnetic holding force of the adjacent permanent magnet is overcome and therefore suppressed.

Only a short-term application of the compressed fluid, which is sufficient to move the switch element towards the respective counter contact is required to move the switch element towards the counter contact. As soon as the contact end is attracted magnetically by the relevant permanent magnet, the fluid flow emitted by the nozzle can be switched off again, thereby achieving a saving of pressurized fluid.

The embodiments according to the invention can also be very advantageously combined with a switch element in the form of a plate spring, of which the broad sides face towards the respectively-associated permanent magnet and/or the respectively-associated nozzle. In this context, the switch element can have the dimensions of a thin film, so that the switch element can be moved with small motive forces in the direction towards the respectively-opposite counter-contact element, with which it can be held in contact. In this context, the switch element does not need to be moved towards the respectively-associated permanent magnet. In the contact position, the contact-holding function is also guaranteed by a sufficient magnetic force of the permanent magnet if a sufficient distance between the switch element and the permanent magnet is present.

The embodiment according to the invention is ideally suitable for a switching device, in which the switch elements are arranged in a preferably-sealed protective compartment of a housing. In this case, the housing should be designed with an outlet, through which the incoming pressurized fluid can escape.

The pressure in the pressurized fluid can be generated, for example, by a pump with at least one piston capable of reciprocal movement or with at least one membrane capable of reciprocal movement or by a compressor.

Furthermore, a contribution is made towards a simple and small-scale design, if two switch elements are arranged with a longitudinal distance opposite to one another with reference to a transverse plane and can be moved transversely towards the associated permanent magnet with their respective, mutually-facing contact ends. In this context, a common permanent magnet is preferably arranged on each side. This allows a simple realization of a four-pin switching device.

Further developments of the invention achieve simple design and attachment features, which guarantee a small, interference-free, durable design with secure function and secure contacting.

Advantageous further embodiments of the invention are explained in greater detail with reference to several exemplary embodiments and drawings. The drawings are as follows:

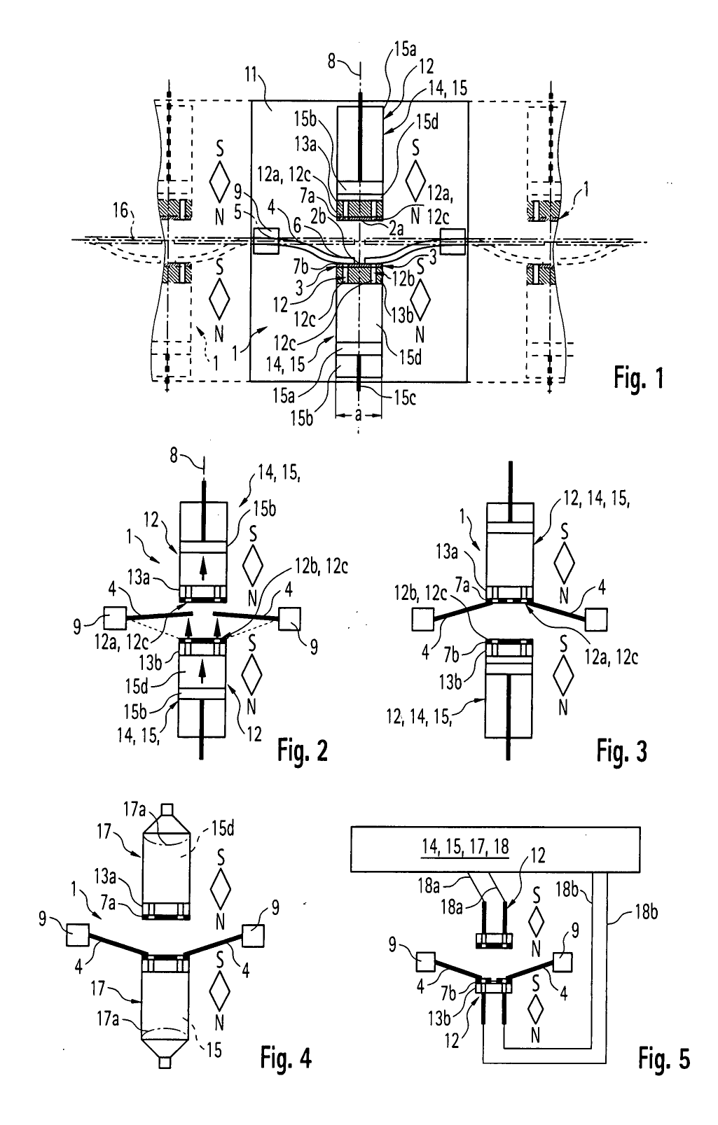

FIG. 1 shows a schematic view of an electrical switching device according to the invention in a switching position;

FIG. 2 shows the switching device in another functional position;

FIG. 3 shows the switching device in another switching position;

FIG. 4 shows a switching device according to the invention in a modified embodiment;

FIG. 5 shows a switching device according to the invention in another modified embodiment;

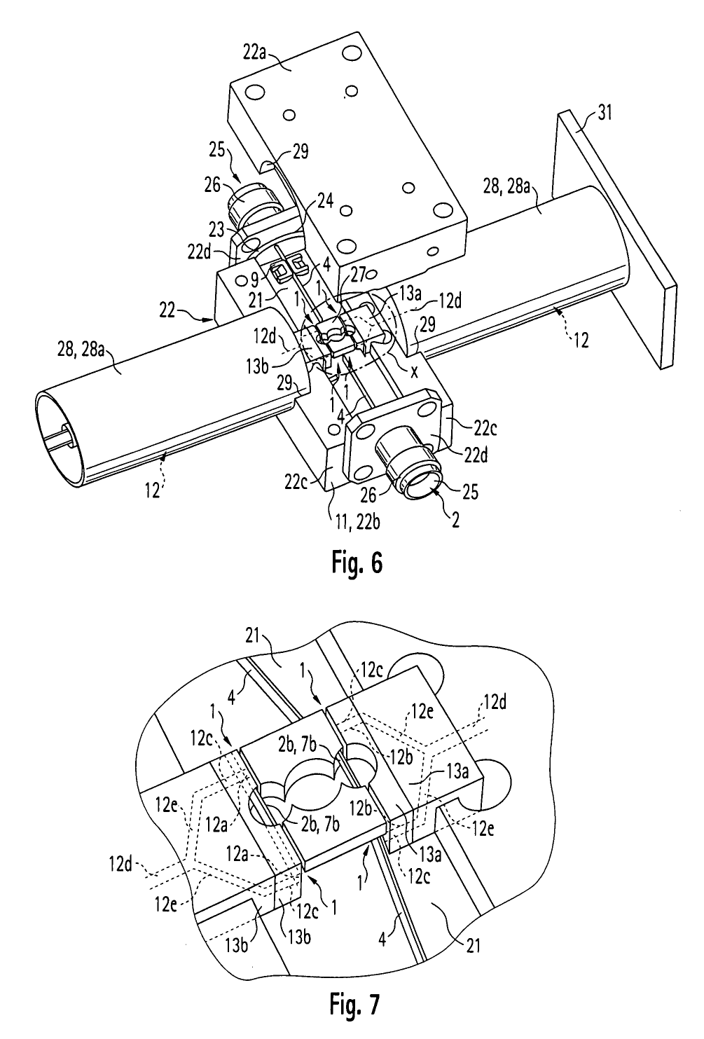

FIG. 6 shows a switching device according to the invention in another modified embodiment;

FIG. 7 shows an enlarged view of the detail marked with X in FIG. 6;

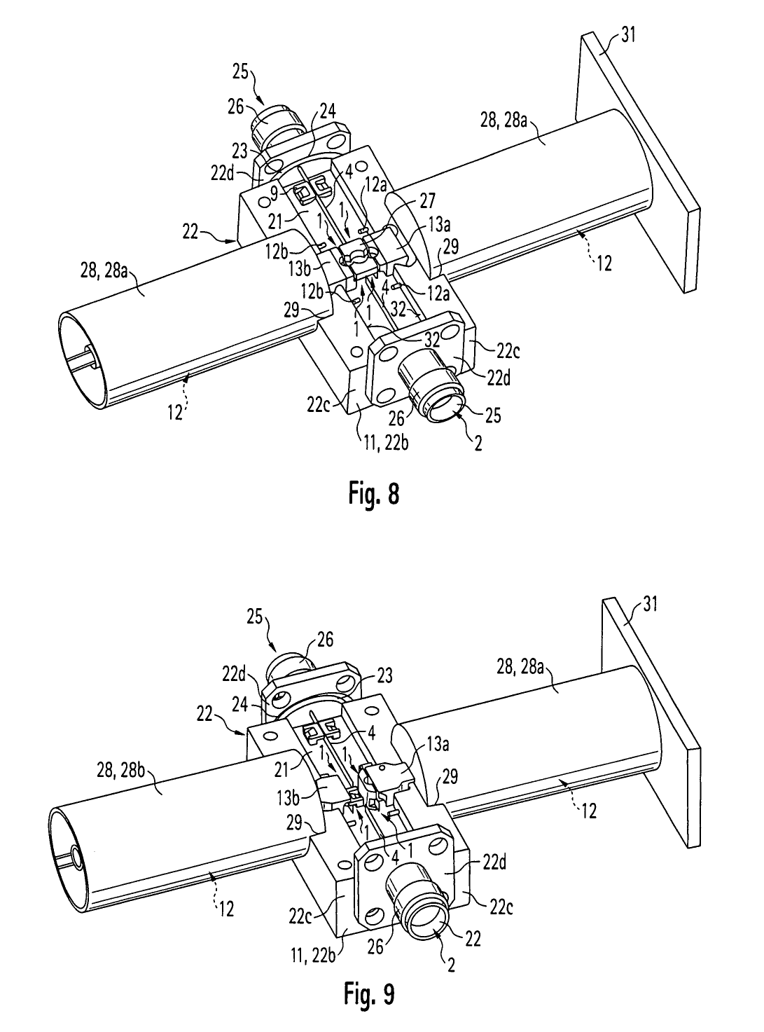

FIG. 8 shows a switching device according to the invention in another modified embodiment and

FIG. 9 shows a switching device according to the invention in another modified embodiment.

The switching device, which is marked as a whole with the reference number 1, provides an electrical line 2 with one or more switches 3 each with a switch element 4, which can be moved reciprocally in a direction transverse to the electrical line 2 and which is used to open or close the line 2. The switch element 4 is an oblong element, which is permanently connected to the line 2 at its lower end 5 and provides a contact end 6 at its other end, with which, after a transverse movement into its contact position, it is in contact with one of two counter-contact elements 7a, 7b arranged at a transverse distance from one another. An open setting is provided in the middle position, wherein the contact end 6 is disposed at a lateral distance from the counter-contact elements 7a, 7b, as suggested by the sketched lines in the drawing.

In the exemplary embodiment, the switching device 1 is part of a so-called calibration line with calibration-line portions 2a, 2b arranged in parallel, which can be switched optionally, wherein at least one calibration-line portion is attenuated and forms an attenuation line. The drawing shows a four-pin calibration line formed by four switches 3 with two calibration-line portions 2a, 2b and two switch elements 4 preferably identical in shape, which are arranged in mirror image to one another on both sides of a transverse plane 8 extending transversely to the electrical line 2 and approximately centrally between the counter-contact elements 7a, 7b, so that their contact ends 6, which are arranged between two laterally-spaced counter-contact elements 7a, 7b, are directed towards one another and can be moved optionally towards the one or the other counter-contact element 7a, 7b. Since the arranged in mirror image on both sides of the transverse plane 8 are essentially the description below relates only to the switching device disposed on the left of the transverse plane 8.

The switch element 4 is preferably capable of lateral, resilient bending, wherein its lower end 5 is held in a holder 9, which is attached to a base 11. A spring reed in the form of a flat strip, as shown in plan view in FIG. 1 with its narrow side visible and its two mutually-facing broad sides facing towards the counter-contact element 7a, 7b, is particularly suitable as a bending switch element. The flat strip can also be made of a thin film, the thickness of which is less than 1/10 mm, for example, only a few μm.

According to a first exemplary embodiment of the invention, for the implementation of a switching process, in which the switch element 4 is moved laterally towards the one or the other of the counter-contact elements 7a, 7b, a nozzle 12a, 12b is provided for the lateral movement of the contact end 6 in the direction towards the one or the other counter-contact element 7a, 7b. To implement a switching process, the respective nozzle 12a, 12b is charged with a compressed fluid, preferably compressed air, so that the fluid flow impinges on the facing side of the switch element 4, especially its broad side, so strongly that the switch element 4 with its contact end 6 is moved towards the respective counter-contact element 7a, 7b to be contacted, with which it comes into contact. When using a switch element made of resilient flexible material, for example, a spring reed in the form of a flat strip, the resilient returning force of the switch element 4 must be overcome during this movement. The charging with the compressed fluid must be maintained for as long as the relevant electrical contact is to be closed. After the termination of the desired switching time, the respective nozzle 12a, 12b is switched off again, after which the switch element 4 can either remain in its position or, as in the exemplary embodiment, may automatically spring back to its central position because of its resilient bending stress.

According to a second exemplary embodiment, a permanent magnet is arranged on each side of the switch element in such a manner that it can attract the switch element 4 through its magnetic force and hold it on the respective counter-contact element 7a, 7b, wherein the efficacy of the permanent magnet, which is disposed opposite to the contact element 7a, 7b to be contacted, can be reduced or cancelled. The permanent magnets therefore provide a magnetic force, which is sufficient to attract the switch element 4 disposed within the movement range and to hold it against the associated counter-contact element 7a, 7b. Since the magnetic force of the respective, opposing magnet 13a, 13b is reduced or cancelled, the operational permanent magnet is capable of moving the switch element 4 towards the associated counter-contact element 7a, 7b and holding it there.

With the exemplary embodiment according to FIG. 1 and the exemplary embodiments still to be described, the respective switching device 1 provides the nozzles 12a, 12b and the permanent magnets 13a, 13b. With this combined exemplary embodiment, the respective nozzle 12a, 12b only needs to apply a motive force with its respective fluid flow of such a magnitude that it moves the switch element 4 towards the associated counter-contact element 7a, 7b. The associated permanent magnet then fulfils the contact-holding function by holding the switch element 4 against the counter-contact element. However, the magnetic force of the permanent magnet can also support the movement of the switch element 4 towards the associated contact element 7a, 7b.

The associated nozzle 12a, 12b can be switched off as soon as the relevant permanent magnet 13a, 13b can independently attract and/or hold the switch element 4 through its magnetic force.

In the exemplary embodiment, the permanent magnet 13a, 13b is disposed behind the associated counter-contact element 7a, 7b with reference to the switch element 4, wherein the permanent magnet 13a, 13b is formed by a disk or a block with, for example, a flat front side facing towards the switch element 4, with which the associated counter-contact element 7a, 7b in the form of a plate, strip or film is in contact and can be attached, for example, by gluing or soldering.

The respective nozzle 12a, 12b is arranged and aligned laterally next to the switch element 4 in such a manner that its nozzle opening is directed towards the side of the switch element facing it, which is preferably a broad side. In the exemplary embodiment, the nozzle 12a, 12b is integrated in the counter-contact element 7a, 7b and the permanent magnet 13a, 13b and formed by a through borehole 12c in the permanent magnet 13a, 13b and in the counter-contact element 7a, 7b. The nozzle 12a, 12b and/or the through borehole 12c is connected at the rear to a supply line for the compressed fluid, preferably compressed air.

The dimensions of the counter-contact element 7a, 7b and the permanent magnet 13a, 13b directed transversely to the plane of the drawing are sufficiently large to provide, on the one hand, an adequate contact point and, on the other hand, an adequate magnetic-field area. In the exemplary embodiment, a common counter-contact element 7a, 7b and a common permanent magnet 13a, 13b are formed on each side and provide a dimension “a” in the longitudinal direction of the line 2 sufficiently large to allow the two mutually facing contact ends 6 of the switch elements 4 overlap sufficiently far in order to guarantee, on the one hand, a sufficiently large contact point and, on the other hand, a sufficiently large magnetic field. Accordingly, two nozzles 12a, 12b and respective through boreholes 12c are disposed in the end regions of the common counter-contact element 7a, 7b and/or permanent magnets 13a, 13b in such a manner that their positions are directed towards the end region of the associated contact end 6.

On each side of the switch element 4 and/or the switch elements 4, a common pressure source 14 is also provided for charging the respective nozzles 12a, 12b with a compressed fluid, especially compressed air. In the case of the embodiment shown in FIG. 1, a piston pump 15 in the form of a cylinder with a cylinder housing 15a and a piston 15b with a piston rod 15c is provided at the rear of each permanent magnet 13a, 13b. The permanent magnet 13a, 13b and the counter-contact element 7a, 7b can therefore form the end wall of the cylinder housing facing towards the switch elements 4, wherein the nozzles 12a, 12b and respectively the through boreholes 12c extend directly from the compression chamber 15d of the cylinder. On the other side respectively of the switch elements 4, the associated contact element 7b, the permanent magnet 13b and the pressure source 14 are arranged and formed in mirror image with reference to a vertical longitudinal plane 16 of the switching device 1.

In the functional position illustrated in FIG. 1, the switch elements 4 are disposed in a position connecting the calibration-line portion 2b in an electrically-conductive manner, wherein the contact ends 6 are in contact with the permanent magnet 13b and are held in contact by its magnetic force.

In order to switch over the switch elements 4 into a position contacting the calibration-line portion 2a, the piston 15b illustrated in FIG. 2 is moved upwards by a piston drive, which is not illustrated, wherein the fluid disposed in the piston chamber is emitted as a fluid flow from the nozzles 12b and releases the switch elements 4 from the contact position with the lower permanent magnet 13b and moves them upwards towards the opposite counter-contact element 7a and respectively permanent magnet 13a. In this position, the switch elements 4 are held in contact with the counter-contact element 7a by the magnetic force of the upper permanent magnet 13a, as shown in FIG. 3. For example, at the same time, the upper piston 15b can be moved upwards, in order to be available for a movement of the switch elements 4 from the position shown in FIG. 3 into the position shown in FIG. 1. In this context, the fluid flow can move the associated switch element 4 towards the relevant permanent magnet 13a, wherein the latter supports the movement through its magnetic force.

Accordingly, if the magnetic force of the permanent magnet 13a is sufficiently large, the thrust of the respective fluid flow only needs to be sufficiently large to move the switch element 4 beyond the central position. From this position, the permanent magnet 13a disposed opposite can draw the switch element towards it and towards the counter-contact element 7a and hold it in contact for the required time. As soon as the effective magnetic force of the respective permanent magnet is sufficiently large to draw the switch element 4 beyond the central position towards it, the associated nozzle can be switched off, because neither it nor the fluid flow are now required.

The switch element 4 can be a double switch element extending preferably in one-piece beyond the holder or holders 9, which projects from the holder 9 in both longitudinal directions, wherein the switch elements 4a facing away from one another cooperate with further movement drives 12 and counter-contact elements 7a, 7b of further calibration-line portions, which are suggested with sketched lines. This is shown in FIG. 1 by the dotted lines on the right and the left.

With the embodiment according to FIG. 4, in which identical or comparable components are marked with the same reference numbers, a membrane pump 17 with a membrane 17a, which generates a gas pressure and/or air pressure in the compression chamber 15d and can be switched on and off according to the function described above, is provided respectively instead of a piston pump.

A common pressure source 14, for example, in the form of a piston pump 15 or membrane pump 17 can also be provided for the nozzle drives disposed on both sides of the central longitudinal plane 16, for example, as shown in FIG. 5, in which a separate and common compressor 18, which is connected to the nozzles 12a, 12b by supply lines 18a, 18b, is provided. The compressed air can optionally be conducted to the nozzles 12a, 12b through valves arranged in the supply lines 18a, 18b, which are not illustrated in the drawing.

In order to protect the mutually-cooperating contact surfaces from contamination from the outside, it is advantageous to arrange the switching device 1, at least with reference to the parts with contact surfaces, in a protective compartment 21 of a preferably-sealed housing 22. In the case of the exemplary embodiments, in which nozzles 12a, 12b are provided as described above, an outlet aperture (not illustrated) is provided in the wall of the protective compartment 21, which aperture preferably opens automatically by means of a closure device (not illustrated), whenever the nozzles 12a, 12b generate a positive pressure inside the compartment, and closes automatically whenever the pressure falls to a given value.

The exemplary embodiment according to FIG. 6, in which identical or comparable parts are also marked with the same reference numbers, shows a housing 22 of this kind in perspective view from above, wherein the protective compartment 21 can optionally be opened and closed by a cover 22a at the top.

With the design according to FIG. 6, the base 11 is formed by a housing base 22b and two mutually-opposing side walls 22c, the cover 22a, which can be fitted onto the latter, and two mutually-opposing end walls 22d, which are fitted and bolted at the ends to the housing base 22b and the side walls 22c. By preference, the end walls 22d project beyond the side walls 22c, so that they can accommodate the cover 22a between them and can also be bolted to the latter. In order to improve the seal of the flat internal attachment of the end walls 22d, they can be sealed with a respective sealing ring 23 made from resilient, compressible material such as rubber or synthetic material, which is preferably seated in an angular groove 24 in the contact surface of the end walls 22d and projects slightly above the contact surface.

A borehole 25 for the electrical line 2 with a sleeve-like cable screw 26, which projects towards the outside, and through which the electrical line 2 extends into the protective compartment 21, is arranged respectively in the central region of the end walls 22d and sealed, for example, by screw connection.

The holders 9 for the switch elements 4 are preferably disposed in the end regions of the protective compartment 21. The holders 9 can each be formed by a clamping device with clamping jaws, between which the associated switch element 4 can be clamped.

FIGS. 6 and 7 show a common supply line 12d respectively for the nozzles 12b arranged on both sides of the transverse plane 16. Two branch lines 12e can extend, for example, from the respective, common fluid connection to the channels or respective boreholes 12c in the magnets 13a, 13b and counter-contact elements 7a, 7b. Fluid connections of this kind can also be provided in the exemplary embodiment according to FIG. 5.

With exemplary embodiment according to FIGS. 6 and 7, the calibration-line portions 2a, 2b and respectively counter-contact elements 7a, 7b are arranged in the lower region of the magnets 13a, 13b. In the upper region, that is to say, above the switch elements 4, a bridge component 27 can be arranged and attached between the permanent magnets 13a, 13b, of which the longitudinal dimension corresponds, for example, to the longitudinal dimension of the permanent magnets 13a, 13b.

The movement drives 12 suggested in the drawing are arranged at the side walls of the housing 22 in the region of the switching device 1 in laterally-projecting drive housings 28, which provide, for example, laterally-projecting pipes 28a, especially of round cross-section, which are arranged in suitable recesses 29 in the lower part of the housing and in the cover 22a.

The movement drives 12 can be, for example, the movement drives described above. Within the framework of the invention, it is also possible to provide electromagnets instead of permanent magnets 13a, 13b, of which the magnetic force in the switched-on condition is respectively sufficiently strong to attract the associated switch element 4 towards it and to hold it in contact with the associated counter-contact element. The magnetic force of the opposing electromagnet is either reduced for the respective switching process or the electromagnet is switched off, so that the respectively-active electromagnet can attract the switch element 4. In the presence of switch elements 4 in the form of spring reeds, as described above, the relevant switch element 4 is drawn from its respective central position towards the contacting counter-contact element 7a, 7b.

This variant with electromagnets is also suitable for an arrangement and operation with or without the nozzles 12.

An associated electronic control device 31 can be arranged on one of the two drive housings 28, for example, at its end facing away from the housing 22.

The exemplary embodiment according to FIG. 8, in which identical or compatible components are marked with the same reference numbers, and in which the cover 22a has been omitted for reasons of clarity, differs from the exemplary embodiments previously described in that the nozzles 12 are arranged in the longitudinal direction of the switch elements 4 near to the counter-contact elements 7a, 7b and respectively magnets 13a, 13b on the lower part of the housing. With a sufficiently strong fluid flow, the switch elements 4 can also be moved in this longitudinal region, which is disposed further away from the contact end 6.

In the exemplary embodiment according to FIG. 8, the nozzles 12a, 12b are formed by tubes projecting from the inner sides 32, which can be inserted, for example, into boreholes in the inner sides 32. In these exemplary embodiments, supply line portions each extend through the side walls 22c to the nozzles 12a, 12b.

In the case of the exemplary embodiments according to FIG. 6 to 8, the permanent magnets 13a, 13b are formed, for example, in the shape of a solder block.

In the exemplary embodiment according to FIG. 9, in which identical or comparable components are also marked with the same reference numbers, permanent magnets 13a, 13b formed, for example, in the shape of a fork, are provided. The magnets disposed opposite to one another preferably face one another respectively with opposite poles N, S.

Within the framework of the invention, several switching devices 1 can be arranged successively in the housing 22 or respectively in its protective compartment 21 in the longitudinal direction of the line 2, as suggested in outline in FIG. 1.

The invention is not restricted to the exemplary embodiments presented. Any of the elements described and illustrated can be combined with one another as required.

1. Electrical switching device, with an oblong, electrical switch element arranged with one contact end between two counter-contact elements providing spaced a transverse distance from one another, which switch element can be moved transversely relative to a longitudinal direction optionally towards the one or the other counter-contact element by two adjustment elements disposed on both sides and near to the switch element 4)
wherein
the switch element comprises magnetic material, and the adjustment elements are formed by magnets, wherein the efficacy of the magnet arranged respectively on the side opposite to the counter-contact element can be reduced or cancelled to allow a switching process.

2. Switching device according to claim 1,
wherein
the efficacy of the magnet can be reduced or cancelled by a fluid flow from a nozzle arranged on the same side and directed towards the side of the switch element facing it and can optionally be switched on and off.

3. Electrical switching device, with an oblong, electrical switch element arranged with a contact end between two counter-contact elements spaced a transverse distance from one another, which switch element can be moved transversely relative to a longitudinal direction optionally towards the one or the other counter-contact element by two adjustment elements disposed on both sides and near the switch element and
at least one nozzle for a compressed fluid directed towards the side of the switch element facing it and arranged respectively on the side of the switch element, on which the counter-contact elements are arranged.

4. Switching device according to claim 3,
wherein
the switch element comprise magnetic material, and a magnet for holding the contact element in contact with the respective counter-contact element by magnetic force arranged on each side of the switch element.

5. Switching device according to claim 4, wherein
the magnets are permanent magnets or electromagnets, of which the magnetic force can optionally be reduced or switched off.

6. Switching device according to claim 3, wherein
the switch element is capable of transverse resilient bending.

7. Switching device according to claim 6,
wherein
the switch element is formed by a spring reed, having broad sides which face towards the counter-contact elements.

8. Switching device according to claim 4, wherein
the magnets are arranged behind the counter-contact elements.

9. Switching device according to claim 8,
wherein
the counter-contact elements are each firmly connected to the associated magnets.

10. Switching device according to claim 3, wherein
two switch elements are arranged opposite to one another with reference to a transverse plane and can be moved transversely with mutually-facing contact ends towards counter-contact elements arranged at both sides, and at least one of a magnet and a nozzle is assigned to the side respectively opposite to the two switch elements.

11. Switching device according to claim 3 wherein
either a pressure source is assigned to each of the nozzles or a common pressure source is assigned to the nozzles which is connected to the nozzles via supply lines.

12. Switching device according to claim 11, wherein
the pressure source or the pressure sources is or are formed respectively by a piston pump or a membrane pump or a compressor.

13. Switching device according to claim 4, wherein
the nozzles are borne by the counter-contact elements and/or by the magnets.

14. Switching device according to claim 4, wherein
the nozzles are arranged near to the counter-contact elements and/or the magnets.

15. Switching device according to claim 3, wherein
one or more switching devices arranged in succession in the longitudinal direction is or are disposed in a protective compartment of a housing.

16. Switching device according to claim 3, wherein
the fluid flow is a gas flow.

17. Switching device according to claim 8, wherein the magnets are in contact with rear sides of the counter-contact elements.

18. Switching device according to claim 9, wherein the counter-contact elements are soldered to the associated magnets.

19. Switching device according to claim 13, wherein the nozzles are defined by boreholes found in the magnets and the counter-contact elements.
